(19) United States
(12) Patent Application Publication
(10) Pub. No.: US 2014/0076490 A1
(43) Pub. Date: Mar. 20, 2014

(54) TRANSPARENT ELECTRODE AND MANUFACTURING METHOD OF THE SAME

(71) Applicant: Hiroshi TAKADA, Tokyo (JP)

(72) Inventor: Hiroshi TAKADA, Tokyo (JP)

(73) Assignee: Konica Minolta Holdings, Inc., Tokyo (JP)

(21) Appl. No.: 14/088,640

(22) Filed: Nov. 25, 2013

Related U.S. Application Data
(62) Division of application No. 12/260,554, filed on Oct. 29, 2008.

(30) Foreign Application Priority Data
Nov. 7, 2007 (JP) 2007-289424

(51) Int. Cl. H01B 13/00

(52) U.S. Cl. CPC H01B 13/00
USPC 156/249

(57) ABSTRACT

Disclosed is a transparent electrode containing a transparent support having thereon: a conductive layer A having a conductive fiber; and a conductive layer B having a conductive polymer, wherein the conductive layer A and the conductive layer B are disposed adjacent each other and the conductive layer A is located nearer to the transparent support than the conductive layer B; and a first surface of the conductive layer B contacting with the conductive layer A has a smoothness Ra(B): Ra(B)≦30 nm.

This application is a Divisional of U.S. patent application Ser. No. 12/260,554 filed Oct. 29, 2008 which claimed the priority of Japanese Patent Application No. 2007-289424 filed on Nov. 7, 2007, the entire contents of each of these applications are hereby incorporated by reference herein.

### TECHNICAL FIELD

The present invention relates to a transparent electrode, exhibiting both high electrical conductivity and excellent transparency, which is appropriately employable in various fields such as liquid crystal display elements, organic luminescent elements, inorganic electroluminescent elements, solar cells, electromagnetic wave shields, or touch panels, and a manufacturing method of the aforesaid transparent electrode.

### BACKGROUND

In recent years, along with an increased demand for thinner TVs, developed have been display technologies of various systems such as liquid crystals, plasma, organic electroluminescence, and field emission. In any of the displays which differ in the display system, transparent electrodes are prepared by employing an essential constituting technology. Further, other than TVs, in touch panels, cellular phones, electronic paper, various solar cells, and various electroluminescence controlling elements, transparent electrodes have become an indispensable technical component.

Heretofore, known as transparent electrodes are thin films of various metal such as Au, Ag, Pt, or Cu; thin metal oxide semiconductor films such as indium oxides (ITO and IZO) doped with tin and zinc, zinc oxides (AZO and GZO) doped with aluminum or gallium, or tin oxides (FTO and ATO) doped with fluorine or antimony; thin conductive nitride films such as TiN, ZrN, or HfN; and thin conductive boron compound films such as LaB₆. Further, known are various electrodes such as Bi₂O₃/Au/Bi₂O₃ or TiO₂/Ag/TiO₂, which are prepared by combining the above. Other than inorganic compounds, proposed are transparent electrodes employing conductive polymers (refer, for example, to Non-Patent Document 1).

However, with regard to the above thin metal film, thin nitride film, and thin boride film, characteristics of both light transmittance and electrical conductivity are not compatible, whereby they have been employed only in the particular technical field such as an electromagnetic wave shield. On the other hand, since the light transmittance and electrical conductivity of the metal oxide semiconductor thin-film are compatible and their durability is excellent, they become mainstream. Specifically, of exemplified oxide semiconductor materials, ITO is in wide use as a transparent electrode for various optoelectronics due to desirably balanced light transmittance and electrical conductivity, and easier fine pattern formation of electrodes via wet etching employing an acid solution.

On the other hand, in various portable devices such as cellular phones and electronic paper, light controlling elements, and solar cells, in addition to enhancement of light transmittance, a decrease in surface electrical resistivity, as well as a decrease in thickness of transparent electrodes, a decrease in weight, and enhancement of flexibility in addition to surface smoothness are highly demanded, whereby various approaches have been carried out.

Technical approach to enhance flexibility is divided mainly into two parts. The former is a review of conventional rigid substrates in which, instead of a glass substrate, a polymer resin film substrate, which excels in flexibility and moisture resistance, is intended to be employed as a substrate. The latter is a trial in which in addition to the above changes of a substrate, transparent electrode materials themselves are improved so that higher flexibility is assured.

In the first approach, an electrode is investigated which is prepared in such a way that for example, a transparent conductive film composed of ITO is formed on a 0.1-2 mm thick polymer resin film via a vacuum film preparing method such as a sputtering method or an ion plating method. During the above preparation, upon considering thermal deterioration and mechanical strength during the vacuum film preparation, employed as a polymer resin film is polyethylene terephthalate (PET), polyethylene naphthalate (PEN), polyether sulfone (PES), or polycarbonate (PC) (refer, for example, to Patent Documents 1-3).

However, in the conventional film preparation method employing a glass substrate, it is possible to set the substrate temperature in the range of about 300-about 400° C., whereby it is possible to form an ITO film of high crystallinity. On the other hand, when a polymer resin film is employed, it is impossible to set a high temperature during film preparation in view of heat resistance, whereby crystallinity of the ITO film is lowered. As a result, at present, a transparent electrode is not realized which satisfies both characteristics of light transmittance and surface resistance. Further, since an ITO film itself is a kind of ceramic and a crystalline ITO film with a low resistance value is columnar in terms of structure, it exhibits difficulty to follow bending and elongation whereby high flexibility is not yet assured.

Consequently, disclosed as a second approach are a method in which a transparent conductive film is formed by applying, onto a support, a dispersion incorporating conductive oxide particles composed of indium oxide and tin oxide, followed by a heat treatment, and another film preparation method in which the surface of minute inorganic oxide particles applied onto a substrate is dissolved and stabilized via the following heat treatment (refer, for example, to Patent Documents 4 and $5).

However, since these methods necessitate heating treatments during formation of the conductive transparent film, it is impossible to apply them to cases in which the conductive transparent film is formed on a polymer resin film. Further, conductive transparent pastes and materials called conductive transparent ink, which are commonly commercially available, necessitate heating treatments and sintering treatments after formation of the coated film to realize the desired high electrical conductivity, whereby they are not suitable for application to rein supports.

As transparent electrode materials listed are conductive polymer materials represented by conjugated polymers. When conductive polymer materials are employed, it is possible to form a transparent electrode body in such a manner that they are dissolved or dispersed in appropriate solvents and if needed, binder components are incorporated, and the resulting mixture is coated or printed (refer, for example, to Patent Document 6). However, when compared to metal oxide transparent-electrodes such as ITO, prepared by a vacuum film preparing method, electrical conductivity is lower and transparency is degraded.

Further, disclosed are technologies employing conductive fibers such as carbon nanotubes (CNT) or metal nanowires. It is proposed to form a transparent electrode in such a manner that some of a conductive fiber are fixed to a substrate by employing the transparent resin film and some of the conductive fibers are exposed or form projections on the surface of the transparent resin film (refer, for example, to Patent Documents 7-9). However, the transparent electrode, constituted as above, exhibits no function as a plane. Further, due to the presence of exposed or projected conductive fibers on the surface, it is not possible to apply the smoothness of the electrode surface to desired technical uses.
(Patent Document 1) Japanese Patent Publication Open to Public Inspection (hereinafter referred to as JP-A) No. 6-145964
(Patent Document 2) JP-A No. 8-64034
(Patent Document 3) JP-A No. 8-17267
(Patent Document 4) Japanese Patent No. 3251066
(Patent Document 5) JP-A No. 2006-245516
(Patent Document 6) JP-A No. 6-273964
(Patent Document 7) JP-A No. 2005-255985
(Patent Document 8) Japanese Patent Publication Open to Public Inspection under PCT Application) No. 2006-519712
(Patent Document 9) U.S. Patent Open to Public inspection No. 2007/0074316A
(Non-Patent Document 1) “Tomei Dendomaka no Gijutsu (Technologies of Transparent Conductive Films”, page 80 (Ohmsha, Ltd.

### SUMMARY

As noted above, none of the technologies, described in the conventional literature, made it possible to overcome drawbacks to prepare transparent electrodes which satisfied each of the various targeted characteristics. Accordingly, an object of the present invention is to provide a transparent electrode which satisfies each of the characteristics such as high light transmittance, low surface resistance, low weight, and flexibility, and further to provide a transparent electrode which excels in surface resistance uniformity and surface smoothness, and a manufacturing method of the aforesaid transparent electrode.

In view of the foregoing, the inventors of the present invention conducted diligent investigations. As a result, it was discovered that by laminating, onto a transparent support, a transparent conductive layer incorporating a conductive fiber and a transparent conductive layer incorporating a conductive polymer so that a smooth surface was formed, it was possible to realize a transparent electrode which exhibited high electrical conductivity and transparency and excelled in uniformity of surface resistance and surface smoothness, whereby the present invention was achieved. Further, by employing a transparent resin film as the transparent support, it is also possible to prepare a transparent electrode which satisfies low weight and flexibility. Namely, the above problems related to the present invention were solved by the following embodiments.

1. A transparent electrode comprising a transparent support having thereon:

a conductive layer A comprising a conductive fiber; and

a conductive layer B comprising a conductive polymer,

wherein the conductive layer A and the conductive layer B are disposed adjacent each other and the conductive layer A is located nearer to the transparent support than the conductive layer B; and

a first surface of the conductive layer B contacting with the conductive layer A has a smoothness Ra(B):

Ra(B)≦30 nm.

2. A transparent electrode of the above-described item 1,

wherein in a second surface of the conductive layer B located farther than the first surface of the conductive layer B from the transparent support has a smoothness Ra(S):

Ra(S)≦5 nm.

3. A method for the transparent electrode of the above-described items 1 or 2, comprising the steps in the sequence set forth:

forming the conductive layer B comprising the conductive polymer on a mold-releasing surface of a mold-releasing support;

laminating the conductive layer A comprising the conductive fiber on the conductive layer B to form a laminated composition; and

transferring the laminated composition of the conductive layer B and the conductive layer A onto the transparent support.

4. A method for the transparent electrode of the above-described items 1 or 2, comprising the steps in the sequence set forth:

forming the layer A comprising the conductive fiber on a mold-releasing surface of a mold-releasing support;

transferring the conductive layer A formed on the mold-releasing surface of the mold-releasing support onto a binder layer comprising a transparent resin provided on a transparent support; and

laminating the conductive layer B comprising the conductive polymer onto the conductive layer A.

According to the above embodiments, it is possible to prepare an transparent electrode which is characterized by high light transmittance, low surface resistance, low weight, and desired flexibility, and excels in uniformity of the surface resistance and surface smoothness. Due to these effects, it is possible to provide a transparent electrode which is applicable to technical uses such as mobile optoelectronic devices, for which low weight and flexibility are demanded, electric current driving type optoelectronic devices for which uniformity of the surface resistance and smoothness of the electrode surface are demanded, or touch panels. Further, since the transparent electrode of the present invention requires no vacuum film formation, it excels in cost reduction and environmental friendliness.

### DESCRIPTION OF THE PREFERRED EMBODIMENT

The present invention will now be detailed.

The transparent electrode of the present invention is characterized in carrying a conductive layer (A layer) incorporating a conductive fiber which are adjacent to each other and a conductive layer (B layer) incorporating a conductive polymer in such a manner that the A layer is arranged nearer to the support. The above characteristic is a technical one which is common to the invention according to the above embodiments 1.-3.

The present invention and the constituting elements thereof, as well as preferred embodiments to practice the present invention will now be detailed.

### (Conductive Layer (A Layer) Incorporating A Conductive Fiber)

As conductive fibers employed in the present invention, listed are carbon based fibrous materials such as carbon nanotubes, carbon nanofibers, or carbon nanowires, metal based fibrous materials such as metal nanowires, metal nanotubes, or metal nanorods, metal oxide based fibrous materials such as metal oxide based nanowires, metal oxide nanowires, or metal oxide nanorods, or composite based fibrous materials which are prepared by coating the surface of organic fibers with metals or metal oxides.

Of these conductive fibers, in view of their conductivity, it is possible to preferably employ carbon nanotubes and metal nanowires. Further, in view of cost (raw material cost and production cost) and performance, it is possible to most preferably employ Ag nanowires. Carbon nanotubes are compounds in which 6-membered ring networks (graphene sheets) which are composed of carbon are structured as a single or multilayered coaxial tube shape. It is known that the conductivity changes depending on the resulting structure.

In the present invention, it is preferable to employ single layer nanotubes which excel in electrical conductivity, and further, it is preferable to employ metallic (a so-called armchair type) single layer carbon nanotubes.

It is possible to prepare the single layer carbon nanotubes via various methods such as carbon targeted laser ablation, hydrocarbon decomposition, or arc discharge between two graphite electrodes. For example, disclosed is a synthetic method of single layer carbon nanotubes, employing gaseous carbon materials and unsupported catalysts (U.S. Pat. No. 6,221,330). Further, reported are isolation technologies of the metallic single layer carbon nanotubes.

It is preferable to employ, as metal nanowires, metal elements of an electrical conductivity of at least 1×10⁶ S/m in a bulk state. As specific examples of nanowires metal elements which are preferable in the present invention listed may be Ag, Cu, Au, Al, Rh, Ir, Co, Zn, Ni, In, Fe, Pd, Pt, Sn, and Ti, as well as alloys thereof. In the present invention, it is possible to employ a combination of at least two types of metal nanowires. However, in view of electrical conductivity, it is preferable to employ elements selected from Ag, Cu, Au, Al, and Co.

It is possible to prepare metal nanowires via various methods such as a liquid phase method or a gas phase method. For example, the manufacturing method of Ag nanowires may be referred to Adv. Mater. 2002, 14, 833-837 and Chem. Mater. 2002, 14, 4736-4745; a manufacturing method of Au nanowires may be referred to JP-A No. 2006-233252; the manufacturing method of Cu nanowires may be referred to JP-A No. 2002-266007; while the manufacturing method of Co nanowires may be referred to JP-A No. 2004-149871.

Specifically, the manufacturing methods of Ag nanowires, described in Adv. Mater. 2002, 14, 833-837 and Chem. Mater. 2002, 14, 4736-4745, may be preferably employed as a manufacturing method of metal nanowires according to the present invention, since via those method, it is possible to simply prepare a large amount of Ag nanowires in an aqueous system and the electrical conductivity of silver is highest of all metals.

In the present invention, metal nanowires produced in an aqueous system may be subjected to a hydrophobic treatment. For example, a method in which metal nanowires are subjected to the hydrophobic treatment may be refer red to JP-A No. 2007-500606.

In the present invention, preferably employed are conductive fibers at an average diameter of 0.3-200 nm. Specifically, in the case of carbon nanotubes, those at an average diameter of 0.3-100 nm are preferably employed, while in the case of metal nanowires, those at an average diameter of 30-200 nm are preferably employed. When the average diameter is at most 200 nm, effects due to light scattering may be preferably reduced and transparency is also preferably enhanced.

The conductive layer incorporating a conductive fiber according to the present invention results in electrical conductivity via formation of three-dimensional conductive network in such a manner that conductive fibers are brought into contact with each other. Accordingly, longer conductive fibers are preferred, which are advantageous for formation of the conductive network. On the other hand, as conductive fibers become longer, conductive fibers intertwine with each other to form aggregates, whereby occasionally, light scattering is deteriorated. Formation of the conductive network and generation of aggregates are affected via the rigidity and the diameter of conductive fibers, whereby it is preferable to employ those of an optimal average aspect ratio (length/diameter), depending on the employed conductive fibers. As a rough target, preferred are those at an average aspect ratio of 10-10,000.

In the present invention, it is possible to determine the above average diameter and average aspect ratio of the conductive fibers as follows. Electron microscopic images of nanowires of a sufficient amount were made. Subsequently, each of the conductive fiber images was measured and the arithmetic average was obtained. The length of conductive fibers should fundamentally be determined in a stretched state to become a straight line. In reality, in most cases, they are curved. Consequently, by employing electron microscopic images, the projected diameter and projected area of each of the nanowires were calculated employing an image analysis apparatus and calculation was carried out while assuming a cylindrical column (length=projected area/projected diameter). The number of nanowires to be calculated is preferably at least 100, but is more preferably at least 300.

The conductive layer incorporating a conductive fiber according to the present invention may incorporate transparent binder materials and additives, other than the conductive fibers. Employable transparent binder materials may be selected from a wide range of natural polymer resins and synthetic polymer resins. Usable examples thereof include transparent thermoplastic resins (for example, polyvinyl chloride, vinyl chloride-vinyl acetate copolymers, polymethyl methacrylate, nitrocellulose, polyethylene chloride, polypropylene chloride, and vinylidene fluoride), as well as transparent resins which are cured via heat, light, electron beams and radiation (for example, melamine acrylate, urethane acrylate, epoxy resins, polyimide resins, and silicone resins such as acryl modified silicate).

The thickness of the conductive layer incorporating a conductive fiber varies depending on the average diameter and content of employed conductive fibers, but as a rough target, is preferably at least the average diameter of conductive fibers to at most 500 nm. It is preferable to decrease the thickness of the conductive layer incorporating a conductive fiber according to the present invention, since it is possible to closely form the network of conductive fibers in the layer thickness direction.

### (Conductive Layer Incorporating a Conductive Polymer (B Layer))

As conductive polymers employed in the present invention, listed are compounds selected from the group consisting of each of the derivatives of polypyrrole, polyaniline, polythiophene, polythienylene vinylene, polyazulene, polyisothianaphthene, polycarbazole, polyacetylene, polyphenylene, polyphenylene vinylene, polyacene, polyphenyl acetylene, and polynaphthalene.

The conductive layer incorporating a conductive polymer according to the present invention may incorporate only one type of a conductive polymer alone or at least two types of conductive polymers in combination. In view of electrical conductivity and transparency, it is more preferable to incorporate at least one compound selected from the group consisting of polyaniline having the repeated unit represented by following Formula (I) and/or following Formula (II) and derivatives thereof, polypyrrole derivatives having one repeated unit represented by following Formula (III), and polythiophene derivatives having the repeated unit represented by following formula (IV).

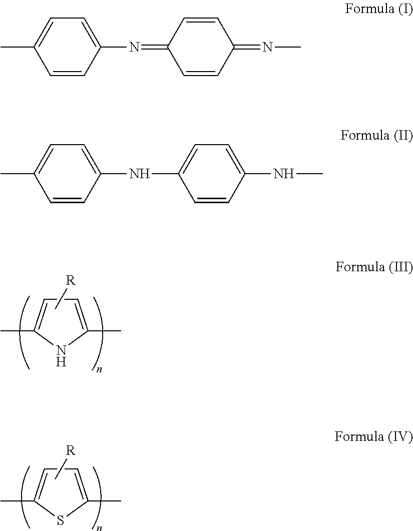

In above Formula (III) and Formula (IV), R is primarily a linear organic substituent, which is preferably an alkyl group, an alkoxy group, or an allyl group, or a combination thereof. Further, these may be combined with a sulfonate group, an ester group, or an amido group or a combination thereof. These may be usable when properties as a soluble conductive polymer are not lost. Still further, “n” is an integer.

Conductive polymers employed in the present invention may be subjected to a doping treatment to further enhance electrical conductivity.

Examples of dopants used for conductive polymers include at least one selected from the group consisting of sulfonic acids (hereinafter referred to as “long chain sulfonic acids”) having a hydrocarbon group with 6-30 carbon atoms or polymers thereof (for example, polystyrenesulfonic acid) or derivatives thereof, halogens, Lewis acids, protonic acids, transition metal halides, transition metal compounds, alkaline metals, alkaline earth metals, MCIO₄ (M=Li⁺ or Na⁺), R₄N⁺ (R═CH₃, C₄H₉, or C₆H₅), or R₄P⁺ (R═CH₃, C₄H₉, or C₆H₅). Of these, the above long chain sulfonic acid is preferred.

The long chain sulfonic acids include dinonyinapthalenedisulfonic acid, dinonylnaphthalenesulfonic acid, and dodecylbenzenesulfonic acid. The halogens include Cl₂, Br₂, I₂, ICl₃, IBr, and IF₅. The Lewis acids include PF₅, AsF₅, SbF₅, BF₃, BCl₃, BBr₃, SO₃, and GaCl₃. The protonic acids include HF, HCl, HNO₃, H₂SO₄, HBF₄, HClO₄, FSO₃H, ClSO₃H, and CF₃SO₃H.

The transition metal halides include NbF₅, TaF₅, MoF₅, WF₅, RuF₅, BiF₅, TiCl₄, ZrCl₄, MoCl₅, MoCl₃, WCl₅, FeCl₃, TeCl₄, SnCl₄, SeCl₄, FeBr₃, and SnI₅. The transition metal compounds include AgClO₄, AgBF₄, La(NO₃)₃, and Sm(NO₃)₃. The alkaline metals include Li, Na, K, Rb, and Cs, while the alkaline earth metals include Be, Mg, Ca, Sc, and Ba.

Further, fullerenes such as hydrogenated fullerene, hydroxidized fullerene, or sulfone-oxidized fullerene may be introduced into the dopants used for conductive polymers.

In the transparent electrode of the present invention, the content of the above dopants is preferably at least 0.001 part by weight with respect to 100 parts by weight of the conductive polymers, but is more preferably at least 0.5 part by weight.

Incidentally, the transparent conductive composition of the present embodiment may incorporate at least one dopant selected from the group consisting of long chain sulfonic acids, polymers (for example, polystyrenesulfonic acid) of the long chain sulfonic acid, halogens, Lewis acids, protonic acids, transition metal halides, transition metal compounds, alkaline metals, alkaline earth metals, MClO₄, R₄N⁺, and R₄P⁺, together with fullerene.

As the conductive polymers according to the present invention, employed may be conductive polymers modified via metal, disclosed in each of Japanese Patent Publication Open to Public Inspection (under PCT Application) No. 2001-511581, and JP-A Nos. 2004-99640 and 2007-165199.

A conductive layer incorporating a conductive polymer (B layer) according to the present invention may incorporate water-soluble organic compounds. Compounds are known which exhibit effects to enhance electrical conductivity via addition to a conductive polymer, and are occasionally called a 2nd. dopant (or a sensitizer). The 2nd. dopants which are usable in the present invention are not particularly limited, and it is possible to appropriately select them from those known in the art. Preferred examples include oxygen-containing compounds.

The above oxygen-containing compounds are not particularly limited as long as they incorporate oxygen. Examples include hydroxyl group-containing compounds, carbonyl group-containing compounds, ether group-containing compounds, and sulfoxide group-containing compounds.

Examples of the above hydroxyl group-containing compounds include ethylene glycol, diethylene glycol, propylene glycol, trimethylene glycol, 1,4-butanediol, and glycerin. Of these, preferred are ethylene glycol and diethylene glycol. Examples of the above carbonyl group-containing compounds include isophorone, propylene carbonate, cyclohezanone, and γ-butyrolactone. Examples of the above ether group-containing compounds include diethylene glycol monoethyl ether. Examples of the above sulfoxide group-containing compounds include dimethyl sulfoxide. These may be employed individually or in combinations of at least two types. However, it is specifically preferred to employ at least one selected from dimethyl sulfoxide, ethylene glycol, and diethylene glycol.

The content of the above 2nd, dopants in the conductive layer incorporating a conductive polymer (B layer) according to the present invention is preferably at least 0.001 part by weight with respect to 100 parts by weight of a conductive polymer, is more preferably 0.01-50 parts by weight, but is most preferably 0.01-10 parts by weight.

In order to assure film forming properties and film strength, the conductive layer incorporating a conductive polymer (B layer) according so the present invention may incorporate transparent resin components (binder materials) and additives, other than the above conductive polymers. With regard to transparent resin components, resin components are not particularly limited as long as they are compatible with or mix-dispersible with conductive polymers. They may be curable resins or thermoplastic resins.

For example, listed as a curable type resin are heat curable type resins, ultraviolet curable type resins, and electron beam curable type resins. Of these curable type resins, in view of simple facilities for resin curable and excellent workability, it is preferable to employ ultraviolet curable type resins. “Ultraviolet curable type resins”, as described herein, refer to those which are cured through crosslinking reactions via exposure to ultraviolet rays, and components are preferably employed which incorporate ethylenic unsaturated double bonds. Examples thereof include acryl urethane based resins, polyester acrylate based resins, epoxy acrylate based resins, and polyol acrylate based resins. In the present invention, it is preferable that as a binder, acryl cased and acryl urethane based ultraviolet curable type resins are employed as a major component.

It is possible to easily prepare the acryl urethane based resins as follows. A product, which is commonly prepared by allowing polyester polyol to react with isocyanate monomers or prepolymers, is further allowed to react with acrylate based monomers having hydroxyl groups such as 2-hydroxyethyl acrylate, 2-hydroxyethyl methacrylate (hereinafter, acrylate includes methacrylate, and they are represented only by acrylates), or 2-hydroxypropyl acrylates. For example, it is possible to employ resins described, in JP A No. 59-151110. For example, preferably employed is a mixture of 100 parts or UNIDICK 17-806 (produced by DIC Corp.; and 1 part of CORONATE L (produced by Nippon Polyurethane Industry Co., Ltd.).

As ultraviolet curable type polyester acrylate based resins, listed may be those which are easily prepared by allowing polyester polyol to react with 2-hydroxyethyl acrylate, 2-hydroxyacrylate based monomers. It is possible to employ those described in JP-A No. 59-151112.

As specific examples of ultraviolet curable type epoxy acrylate based resins listed are those which are prepared in such a manner that epoxyacrylate is employed as an oligomer, and a reaction is carried out by adding reactive diluting agents and photo-reaction initiating agents. It is possible to employ those described in JP-A-1-105738.

As specific examples of ultraviolet curable type polyol acrylate based resins listed may be trimethylolpropane triacrylate, ditrimethylolpropane, tetraacrylate, pentaerythritol triacrylate, pentaerythritol tetraacrylate, dipentaerythritol hexaacrylate, and alkyl-modified dipentaerythritol pentaacrylate.

Of resin monomers, as monomers having one unsaturated doable bond, listed may be common monomers such as methyl acrylate, ethyl acrylate, butyl acrylate, benzyl acrylate, cyclohexyl acrylate, vinyl acetate, or styrene. Further, as monomers having at least two unsaturated double bonds, listed may be ethylene glycol diacrylate, propylene glycol diacrylate, divinylbenzene, 1,4-cyclohexane diacrylate, 1,4-cyclohexyl dimethyl diacrylate, above trimethylolpropane triacrylate, and pentaerythritol tetraacryl ester.

Of these, as a major component of the binders, preferred is the acryl based actinic radiation curable resin selected from 1,4-cyclohexane diacrylate, pentaerythritol tetra(meth)acrylate, pentaerythritol tri(meth)acrylate, trimethylolpropane (meth)acrylate, trimethylolethane (meth)acrylate, dipentaerythritol tetra(meth)acrylate, dipentaerythritol hexa(meth)acrylate, 1,2,3,-cyclohexane tetramethacrylate, polyurethane polyacrylate, and polyester polyacrylate.

As specific examples of photoreaction initiators listed may be benzoin and derivatives thereof, as well as acetophenone, benzophenone, hydroxybenzophenone, Michler's ketone. α-amyloxime ester, and thioxanthone, as well as derivatives thereof, which may be employed together with photosensitizers. The above photoreaction initiators may also be employed as a photosensitizer. Further, when epoxyacrylate based photoreaction initiators are employed, employed may be sensitizers such as n-butylamine, triethylamine, or tri-n′-butylphosphine. The content of photoreaction initiators and photosensitizers employed in the ultraviolet curable type composition, is commonly 0.1-15 parts by weight with respect to 100 parts by weight of the above component, but is preferably 1-10 parts by weight.

### (Transparent Supports)

Transparent supports employed in the present invention are not particularly limited, and their materials, shape, structure and thickness may be selected, from, those known, in the art. For example, listed as appropriate substrates are glass substrates, resin substrates, and resin films in view of excellent hardness and easy formation of a conductive layer on their surface. However, in view of low weight and flexibility, it is preferable to employ the resin films.

The above resins are not particularly limited, and it is possible to appropriately select any of those known in the art. Examples thereof include polyethylene terephthalate resins, polybutylene terephthalate resins, polyethylene naphthalate resins, polyvinyl chloride resins, polyethersulfone resins, polycarbonate resins, polystyrene resins, polyimide resins, polyether imide resins, polyvinyl acetate resins, polyvinylidene chloride resins, polyvinylidene fluoride resins, polyvinyl alcohol resins, polyvinyl acetal resins, polyvinyl butyral resins, methyl polymethacrylate resins, polyacrylonitrile resins, polyolefin polystyrene resins, polyamide resins, polybutadiene resins, cellulose acetate, cellulose nitrate, and acrylonitrile-butadiene-styrene copolymers. These may be employed individually or in combinations of at least two types. Of these, preferred are the polyethylene terephthalate resins which excel in transparency and flexibility.

Transparent resins, which form the transparent support according to the present invention, may incorporate, for any purpose, additives such as plasticizers, stabilizers such as antioxidants, surface active agents, dissolution accelerators, polymerization inhibitors, or colorants such as dyes or pigments. In view of enhancement of workability such as coatability, the above resins may incorporate solvents (for example, water, and organic solvents such as alcohols, glycols, cellosolves, ketones, esters, ethers, amides, or hydrocarbons).

### (Mold-Releasing Support)

As a mold-releasing support employed in the manufacturing method of the transparent electrode of the present invention, appropriately listed, are resin substrates and resin films. The above resins are not particularly limited, and it is possible to appropriately select any of those known in the art. For example, appropriately employed are substrates and films, each of which is structured of a single layer or a plurality of layers composed of synthetic resins such as polyethylene terephthalate resins, vinyl chloride based resins, acryl based resins, polycarbonate resins, polyimide resins, polyethylene resins, or polypropylene resins. Further employed may be glass substrates and various kinds of paper.

Further, if desired, the surface (the mold-releasing surface) of mold-releasing supports may be subjected to a surface treatment via application of releasing agents such as silicone resins, fluororesins, or waxes.

### (Transparent Electrode)

The transparent electrode of the present invention is characterised in that it incorporates a transparent support having thereon a conductive layer (layer A) incorporating a conductive fiber and a conductive layer (layer B) incorporating a conductive polymer which are disposed to be adjacent to each other so that layer A is located on the side nearer to the support and a first surface of layer B in contact with layer A exhibits smoothness Ra(B)≦30 nm. The first surface of layer B in contact with layer A preferably exhibits smoothness Ra(B)≦10 nm, but more preferably exhibits Ra(B)≦5 nm.

Further, in the transparent electrode, the second surface of layer B on the side farther from the support of layer B preferably exhibits smoothness Ra (S)≦3 nm, but more preferably exhibits Ra (S)≦1 nm.

Herein, Ra(B) and Pa(S) each means an arithmetic average (being an average value of the absolute value deviation from the average line), and as the value becomes smaller, smoothness increases. When direct determination is applicable, it is possible to determine Ra(B) and Ra(S) by employing a surface roughness meter. Alternatively, cross-sectional slices, which are perpendicular to the transparent electrode, are prepared via a microtome. Electron microscopic images of at least 10 slices are prepared. Subsequently, by employing an image processor, Ra(B): a roughness curve of layer B surface (the first surface) where layer B comes into contact with layer A, and Ra (S): a roughness curve of layer B surface (the second surface) on the side which is farther from the support of layer B are determined, and thereby, it is possible to obtain the arithmetic average roughness via calculation.

The transparent electrode of the present invention may also be provided, if desired, with various functional layers such as a hard coating layer, a non-glare coating layer, a barrier coating layer, an anchor coating layer, a barrier transporting layer, or a carrier accumulation layer.

When a hard coating layer and a non-glare coating layer are provided, it is preferable that they are arranged on the side opposite the conductive layer across the transparent electrode according to the present invention. When a barrier coating layer is provided, it is preferable that it is arranged between the transparent support and the conductive layer according to the present invention. When an anchor coating layer, the carrier transporting layer, and the carrier storing layer are provided, it is preferable that they are arranged on the sane side as the conductive layer with respect to the transparent support according to the present invention.

The thickness of the transparent electrode of the present invention is not particularly limited, and it is possible to appropriately select the thickness depending on intended purposes. However, commonly the thickness is preferably at most 10 μm. The thickness is more preferably thinner since close contact to supports and transparency are thereby improved.

Total light transmittance of the transparent electrode of the present invention is preferably at least 60%, is more preferably at least 70%, but is most preferably at least 80%. It is possible to determine the total light transmittance based on methods known in the art, employing a spectrophotometer.

Further, the electrical resistance value of the transparent electrode is preferably at most 10⁴Ω/□ in terms of surface resistivity, is more preferably at most 10³Ω/□, but is most preferably at most 10²Ω/□. In the case in which the surface resistivity exceeds 10⁴Ω/□, when employed as liquid crystal displays, transparent electrodes of touch panels, and electromagnetic wave shielding materials, cases occur in which functions as an electrode are not fully realised and electromagnetic wave shielding characteristics are also not fully realized. It is possible to determine the above surface resistivity, for example, based on JIS K7194 or ASTM D267. Further, it is also possible to conveniently determine the same employing a commercial surface resistivity meter.

### (Manufacturing Methods)

Manufacturing methods of the transparent electrode of the present invention are not particularly limited. However, in view of productivity and production cost, electrode qualities such as smoothness and uniformity, as well as reduction of environmental load, in order to form the conductive layer, it is preferable to employ liquid phase film forming methods such as coating methods or printing methods.

As the coating method employed may be a roller coating method, a bar coating method, a dip coating method, a spin coating method, a casting method, a die coating method, a blade coating method, a bar coating method, a gravure coating method, a curtain coating method, a spray coating method, and a doctor coating method, while as the printing method employed may be a letterpress (typographic) printing method, a porous (screen) printing method, a lithographic (offset) printing method, an intaglio (gravure) printing, a spray printing method, and an ink-jet printing method.

Further, it is possible to form transparent wirings and transparent circuits in such a manner that a transparent electrode with characteristics of the present invention is subjected to pattern formation on the transparent support. As a preliminary treatment to enhance close contact and coatability, if desired, the surface of transparent supports may be subjected to a physical surface treatment such as a corona discharge treatment or a plasma discharge treatment.

By employing, for example, the following manufacturing method according to the present invention, it is possible to manufacture the transparent electrode of the present invention which incorporates a transparent support leaving thereon a conductive layer (layer A) incorporating a conductive fiber and a conductive layer (layer B) incorporating a conductive polymer, which are adjacent to each other, so that layer A is arranged on the side nearer the support.

(1) Layer B is formed by applying a liquid coating composition incorporating a conductive polymer onto the mold releasing surface of a mold-releasing support, followed by drying. Subsequently, layer A is formed by applying, onto layer B, a liquid coating composition prepared by uniformly dispersing conductive fibers into volatile liquids, followed by drying. Further, an anchor coating layer is formed. These laminated layers are adhered onto a transparent support, followed by peeling off the mold-releasing support whereby the laminated layers are transferred onto a transparent support.

(2) Layer B is formed by applying, onto the mold-releasing surface of a mold-releasing support, a liquid coating composition incorporating a conductive polymer, followed by drying. Subsequently, a liquid coating composition prepared by uniformly dispersing conductive fibers into volatile liquids is applied onto layer B. Further, a solution incorporating the above transparent binder materials is applied, followed by drying, whereby layer A incorporating a conductive fiber and the binder materials is formed. Further, anchor coating layer is formed. The laminated layers composition is adhered to a transparent support, and the mold-releasing support is peeled off, whereby the laminated layers composition is transferred onto a transparent support.

(3) Layer B is formed by applying, onto the mold-releasing surface, a liquid coating composition incorporating a conductive polymer, followed by drying. Subsequently, layer A is formed by applying, onto Layer B, a liquid coating composition prepared by uniformly dispersing conductive fibers into a solution incorporating the above transparent binder materials, followed by drying. Further, an anchor coating layer is formed. These laminated layers are adhered onto a transparent support, and by peeling off the mold-releasing support, a laminated layers composition is transferred onto a transparent support.

(4) Layer A is formed by applying, onto the mold-releasing surface of a mold-releasing support, a liquid coating composition prepared by uniformly dispersing conductive fibers into a volatile liquid, followed by drying. A binder layer is formed by applying, onto a transparent support, a solution containing transparent energetic ray (ultraviolet ray and election beam) curable resins and heat curable resins, followed by drying. Layer A, formed on the mold-releasing support, is brought into pressure contact with the binder layer, and after curing the binders via application of energetic rays and heat, by peeling off the mold-releasing support, a conductive layer is formed in which layer A is fixed to the surface portion of the binder layer on the transparent support. Further, layer B is formed by applying a liquid coating composition incorporating a conductive polymer onto the above conductive levee, followed by drying.

In the above methods (1)-(2) and (4), enhancement of close adhesion among conductive fibers via a calendering treatment after applying a liquid coating composition, prepared by uniformly dispersing conductive fibers into a volatile liquid, followed by drying, is effective as a method to enhance the electric conductivity of layer A.

Further, in methods (1)-(3), a part of the functional layer (the anchor coating layer as an example of the above manufacturing methods), formed on layer A, occasionally becomes part of layer A via incorporation of a conductive fiber.

In any of rue above methods, the mold-releasing surface of the mold-releasing support to form layer B may previously be subjected to a hydrophilic treatment such as corona discharge (plasma), or the liquid coating composition to form layer B may incorporate the above transparent resin components. Further, an anchor coating layer may be formed on the transparent support side. Still further, a barrier coating layer may previously be formed on the transparent support on the side to be transferred with the laminated layers composition, and a hard coating layer may previously be formed on the transparent support on the reverse side to be transferred with the laminated layers composition. Further, a functional layer such as a carrier transporting layer or a carrier accumulation layer is formed on layer B after preparation of the transparent electrode, or may be formed on the mold-releasing surface of the mold-releasing support prior to formation of layer B.

In method (4), the mold-releasing surface of the mold-releasing support to form layer a may previously be subjected to a hydrophilic treatment such as corona discharge (plasma), and a liquid coating composition to form layer A may incorporate the above transparent resin components. Further, a barrier coating layer may previously formed on the transparent support on the side to form a binder layer, and the hard coating layer may previously be formed on the support on the reverse side to be formed with a binder layer. A functional layer such as a carrier transporting layer or a carrier accumulation layer may be formed on layer B after production of the transparent electrode.

As described above, by employing a manufacturing method in which after formation of layer B via coating, it is possible to readily smoothen the surface of layer B via leveling of the liquid coating composition, whereby it is possible to achieve the targeted smoothness at the interface where layer B is brought into contact with layer A. Further, by retaining smoothness of the surface (the mold-releasing surface in examples of the above manufacturing method) of the substrate to form layer B, it is possible to control smoothness of the surface on the side further from the support of layer B. In the present invention, arithmetic average roughness of the surface of the substrate to form the layer B is preferably at most 5 nm, is more preferably at most 3 nm, but is most preferably at most 1 nm.

As described in method (4), by employing the method in which after forming layer A on the mold-releasing support, via coating, transfer to the binder layer is carried out to be fixed in the surface portion, it is possible to smoothen the surface of the binder layer incorporating layer A, whereby it is possible to provide targeted smoothness at the interface where layer B is brought into contact with layer A. Further, since it is possible to smoothen the surface of layer B due to leveling of the liquid coating composition, it is possible to easily control the smoothness of the surface on the side which is farther from the support of layer B.

### EXAMPLES

The present invention will now be detailed with reference to examples, however the present invention is not limited thereto. In examples, “parts” or “%” is employed and represents “parts by weight” or “% by weight”, respectively, unless otherwise specified. Further, layer A and layer B follow the description of the claims.

### (Conductive Fibers and Conductive Polymers)

In the present examples, Ag nanowires were employed as conductive fibers, while PEDOT/PSS was employed as a conductive polymer. Here, PEDOT is an abbreviation of 3,4-ethylenedioxythiophen and PSS is an abbreviation of polystyrene sulfone. An Ag nanowire dispersion employed in the following examples was prepared as follows.

Ag nanowires at an average diameter of 75 nm and an average length of 6.2 μm were prepared with reference to the method described in Adv. Mater. 2002, 14, 833-837. Ag nanowires were collected via filtration, and washed with water. Thereafter, the resulting Ag nanowires were dispersed into ethanol, whereby an Ag nanowire dispersion (at a content of the Ag nanowires of 5% by weight) was prepared. Further, employed as PEDOT/PSS was BAYTRON RPF500 (produced by H. C. Starck Co.). Further, in any of the examples, coating was carried out via a spin coater.

### Example 1

### <<Preparation of Transparent Electrode>>

### (Preparation of Transparent Electrode C-10)

According to manufacturing method (3) described above, Transparent Electrode TC-10 was prepared.

Layer B was formed by uniformly applying a solution containing PEDOT/PSS and DMSO (dimethyl sulfoxide) onto the mold-releasing surface of a mold-releasing support treated with corona discharge to attain a dried layer thickness of 150 nm, followed by drying. Subsequently, layer A was formed by applying a dispersion which was prepared by uniformly dispersing a mixture of methyl isobutyl ketone, urethane acrylate, and the above Ag nanowire dispersion, followed by drying. Further, the added amount of the urethane acrylate and the Ag nanowire dispersion was regulated so that the thickness of the urethane acrylate film after drying reached 150 nm and the coated weight of the Ag nanowires reached 0.3 g/m². Further, an anchor coating layer was formed on layer A. After the above laminated layers composition was adhered to a polyethylene terephthalate (PET) support of a total light transmittance of 90%, the laminated layers composition was transferred onto a transparent polyethylene naphthalate (PEN) support by peeling off the mold-releasing support, whereby Transparent Electrode TC-0 of the present invention was prepared.

### (Preparation of Transparent Electrode TC-11)

Transparent Electrode TC-11 of the present invention was prepared in the same manner as above Transparent Electrode TC-10, except that the thickness of layer B was changed to 300 nm.

### (Preparation of Transparent Electrode TC-12)

Transparent Electrode TC-12 of the present invention was prepared in the same manner as above Transparent Electrode TC-10, except that layer A was formed to reach a dried layer thickness of 200 nm by regulating the added amount of urethane acrylate.

### (Preparation of Transparent Electrode TC-13

Transparent Electrode TC-13 of the present invention was prepared in the same manner as above Transparent Electrode TC-10, except that the thickness of layer B was changed to 300 nm and layer A was formed to reach a dried layer thickness of 200 nm by regulating the added amount of urethane acrylate.

### (Preparation of Transparent Electrode TC-14)

Comparative Transparent Electrode TC-14 was prepared in such a manner that layer A was formed on a PET support in the same manner as for Transparent Electrode TC-10, and subsequently, layer B was formed in the same manner as Transparent Electrode TC-10.

### (Preparation of Transparent Electrode TC-15)

Comparative Transparent Electrode TC-15 was prepared in such a manner that layer A was formed on a PET support in the same manner as Transparent Electrode TC-11, and subsequently, layer B was formed in the same manner as Transparent Electrode TC-11.

### (Preparation of Transparent Electrode TC-16)

Comparative Transparent Electrode TC-16 was prepared in such a manner that layer A was formed on a PET support in the same manner as Transparent Electrode TC-12, and subsequently, layer B was formed in the same manner as Transparent Electrode TC-12.

### (Preparation of Transparent Electrode TC-17)

Comparative Transparent Electrode TC-17 was prepared in such a manner that layer A was formed on a PET support in the same manner as Transparent Electrode TC-13, and subsequently, layer B was formed in the same manner as Transparent Electrode TC-13.

### (Preparation of Transparent Electrode TC-18)

Comparative Transparent Electrode TC-18 was prepared in such a manner that layer A was formed on a PET support in the same manner as Transparent Electrode TC-10.

### (Preparation of Transparent Electrode TC-19)

Comparative Transparent Electrode TC-19 was prepared in such a manner that layer B was formed on a PET support in the same manner as Transparent Electrode TC-10.

### <<Evaluation>>

Total light transmittance T of each of the transparent electrodes, prepared as above, was determined. Further, the surface of each transparent electrode was divided into 10×10 sections. Subsequently, surface resistance in each of the total 100 positions was determined, and average value SR(a) and standard deviation SR(σ) of the surface resistance were obtained. Further, with regard to Transparent Electrodes TC-10-17, the roughness curve of the interface where layer B comes into contact with the layer A was determined via the above method, whereby smoothness Ra(B) of the surface of layer B where layer B is brought into contact with layer A was obtained. Table 1 shows the results.

TABLE 1

| Transparent | | | | | |
|---|---|---|---|---|---|
| Electrode | T | SR(a) | SR(σ) | Ra(B) | Remarks |
| TC-10 | 86% | 78Ω/□ | 1.2Ω | 2 nm | Present Invention |
| TC-11 | 83% | 82Ω/□ | 0.7Ω | 2 nm | Present Invention |
| TC-12 | 85% | 80Ω/□ | 1.3Ω | 2 nm | Present Invention |
| TC-13 | 82% | 84Ω/□ | 0.8Ω | 2 nm | Present Invention |
| TC-14 | 86% | 85Ω/□ | 9.8Ω | 85 nm | Comparative |
| | | | | | Example |
| TC-15 | 83% | 90Ω/□ | 7.5Ω | 85 nm | Comparative |
| | | | | | Example |
| TC-16 | 85% | 89Ω/□ | 8.2Ω | 45 nm | Comparative |
| | | | | | Example |
| TC-17 | 82% | 92Ω/□ | 6.8Ω | 45 nm | Comparative |
| | | | | | Example |
| TC-18 | 89% | 69Ω/□ | 13.1Ω | — | Comparative |
| | | | | | Example |
| TC-19 | 87% | 146Ω/□ | 0.7Ω | — | Comparative |
| | | | | | Example |

In the results shown in Table 1, it is evident that when Transparent Electrode TC-18 (being a layer A structure) and Transparent Electrode TC-19 (being a layer B structure) are compared, electrical conductivity of layer A is superior, while when the above two layers are laminated, layer A (being formed of Ag nanowire) functions as a major conductor.

In the results shown in Table 1, when Transparent Electrodes TC-10-17 are compared in the same manner as above, it is evident that with respect to comparative electrodes, the total light transmittance of each of the transparent electrodes of the present invention is identical and average surface resistance value (SR(a)) is enhanced, while surface resistance standard variation (SR(σ)) is significantly improved. During determination of above layer B surface smoothness Ra(B), the cross-sectional surface of each of the transparent electrodes was observed. It was confirmed that in comparative transparent electrodes, Ag nanowires of layer A protruded over layer B, while in the transparent electrodes of the present invention, Ag nanowires of layer A did not protruded while coming into contact with the interface of layer B, and many of them existed near the interface.

Accordingly, it is assumed that improvement of the average value of the surface resistance in the transparent electrode of the present invention is realized by the following characteristics of the present invention. Many of Ag nanowires of layer A are brought into contact with the layer B, whereby electrical conductivity between layers A and B is enhanced. Excellent uniformity of the surface resistance is realized in such a manner that the distance between the Ag nanowires, which function as a major conductor, and the surface of the transparent electrode is kept constant (namely, the Ra (B) value is small).

### Example 2

### <<Preparation of Transparent Electrodes>>

### (Preparation of Transparent Electrode TC-20)

According to above manufacturing method (3), Transparent Electrode TC-20 was prepared. Layer B was formed by uniformly applying a solution incorporating PEDOT/PSS and DMSO onto the mold-releasing surface of a mold-releasing support treated with corona discharge to reach a dried layer thickness of 200 nm, followed by drying. Subsequently, coated was an Ag nanowire dispersion to result in a coated weight of 0.3 g/m², followed by drying.

Subsequently, a methyl isobutyl ketone solution of urethane acrylate was applied to reach a dried layer thickness of 400 nm, followed by drying, and the Ag nanowire layer was partially covered, whereby layer A was formed. Further, an anchor coating layer was formed on layer A. After the above laminated layers composition was adhered to the PET transparent support, employed also in Example 1, the laminated layer body was transferred by peeling the mold-releasing support, whereby Transparent Electrode TC-20 of the present invention was prepared.

### (Preparation of Transparent Electrode TC-21)

Transparent Electrode TC-21 was prepared according above manufacturing method (3). Layer B was formed by uniformly applying a solution incorporating PEDOT/PSS and DMSO onto the mold-releasing surface of a mold-releasing support treated with corona discharge to attain a dried layer thickness of 200 nm, followed by drying. Subsequently, by employing a roller which exhibited minute irregularity on its surface, it texture structure was formed on the entire surface of layer B. Thereafter, an Ag nanowire dispersion was applied onto layer B provided with a textured structure to attain a coated weight of 0.3 g/m², followed by drying.

Subsequently, a methyl isobutyl ketone solution of urethane acrylate was applied to reach a dried layer thickness of 400 nm, followed by drying, and the Ag nanowire layer was partially covered, whereby layer A was formed. Further, an anchor coating layer was formed on the layer A. After the above laminated layers composition was adhered to the PET transparent support, employed also in Example 1, the laminated layers composition was transferred by peeling the mold releasing support, whereby Transparent Electrode TC-21 of the present invention was prepared.

### (Preparation of Transparent Electrodes TC-22-24)

Transparent Electrodes TC-22-24 were prepared in the same manner as above Transparent Electrode TC-21, except that the type of roller which formed a textured structure on the surface of layer B was changed (in which the peak-to-valley range of irregularity differed).

### <<Evaluation>>

The perpendicular cross-section of each of the transparent electrodes, prepared as above, was observed, and smoothness Ra(B) of the surface of layer B, which was brought into contact with layer A, was obtained. Further, average value SR(a) and standard deviation SR(σ) of the surface resistance were determined via the same method as in Example 1, and surface resistance distribution D(SR) was obtained by the following formula as an index of fluctuation of surface resistance:

D(SR)=SR(σ)/SR(a)×100(%)

Table 2 shows the results.

TABLE 2

| Transparent | | | | |
|---|---|---|---|---|
| Electrode | Ra(B) | SR(σ) | D(SR) | Remarks |
| TC-20 | 2 nm | 1.0Ω | 1.30% | Present |
| | | | | Invention |
| TC-21 | 8 nm | 1.3Ω | 1.60% | Present |
| | | | | Invention |
| TC-22 | 17 nm | 1.7Ω | 2.10% | Present |
| | | | | Invention |
| TC-23 | 24 nm | 2.3Ω | 2.90% | Present |
| | | | | Invention |
| TC-24 | 42 nm | 5.1Ω | 6.40% | Comparative |
| | | | | Example |

In Table 2, it is noted that along with deterioration of smoothness (Ra(B)) of the surface of layer B, standard variation (SR(σ)) tends to increase. However, in Transparent Electrodes TC-20-23 of the present invention, in which Ra(B)≦30 nm, surface resistance distribution (D(SR)) is retarded to be at most 3%. On the other hand, in comparative Transparent Electrode TC-24 of Ra(B)>30 nm, the surface resistance distribution rapidly deteriorates. It is found that in order to reduce fluctuation of the surface resistance, it is effective to make Ra(B) at most 30 nm.

### Example 1

### <<Preparation of Transparent Electrode>>

### (Preparation of Transparent Electrode TC-30)

Transparent Electrode TC-30 was prepared according to the above manufacturing method (3) of the present invention. Layer B was formed by uniformly applying a solution incorporating PEDOT/PSS and DMSO onto a highly smoothened mold-releasing support at an arithmetic average roughness of at most 1 nm to attain a dried layer thickness of 100 nm, followed by drying, whereby layer B was prepared. Subsequently, an Ag nanowire dispersion was applied to attain a coated weight of 0.3 g/m², followed by drying, whereby an Ag nanowire layer was formed.

Subsequently, a methyl isobutyl ketone solution of methane acrylate was applied to attain a dried layer thickness of 300 nm to cover the Ag nanowire layer, followed by drying, whereby layer A was formed. Further, an anchor coating layer was formed on aforesaid layer A. After the above laminated layers composition was adhered to the transparent PET support employed in Example 1, the laminated layers composition was transferred, by peeling the mold-releasing support, whereby Transparent Electrode TC-30 of the present invention was prepared.

### (Preparation of Transparent Electrode TC-31)

Transparent Electrode TC-31 of the present invention was prepared in the same manner as Transparent Electrode TC-30, except that in the above preparing method of Transparent Electrode TC-30, after an Ag nanowire dispersion was applied, followed by drying, an Ag nanowire layer was subjected to a calendering treatment prior to application of a urethane acrylate solution.

### (Preparation of Transparent Electrode TC-32)

Transparent Electrode TC-32 of the present invention was prepared in the same manner as Transparent Electrode TC-31, except that in the above preparing method of Transparent Electrode TC-31, a highly smoothened mold-releasing support of an arithmetic average roughness of the mold-releasing surface of approximately 2 nm was employed.

### (Preparation of Transparent Electrode TC-33)

Transparent Electrode TC-33 of the present invention was prepared in the same manner as Transparent Electrode TC-31, except that in the above preparing method of Transparent Electrode TC-31, a highly smoothened mold-releasing support of an arithmetic average roughness of the mold-releasing surface of approximately 4 nm was employed.

### (Preparation of Transparent Electrode TC-34)

Transparent Electrode TC-34 of the present invention was prepared in the same manner as Transparent Electrode TC-31, except that in the above preparing method of Transparent Electrode TC-31, a highly smoothened mold-releasing support of an arithmetic average roughness of the mold-releasing surface of approximately 6 nm was employed.

### <<Evaluation>>

Average surface resistance value SR(a) of each of the transparent electrodes, prepared as above, was determined via the same method as in Example 1. Further, smoothness Ra(S) of each transparent electrode surface (namely, the surface which was farther from the support of layer B) was determined. Table 3 shows the results.

TABLE 3

| Transparent | | | |
|---|---|---|---|
| Electrode | SR(a) | Ra(S) | Remarks |
| TC-30 | 76Ω/□ | ≦1 nm | Present |
| | | | Invention |
| TC-31 | 54Ω/□ | ≦1 nm | Present |
| | | | Invention |
| TC-32 | 54Ω/□ | nearly 2 nm | Present |
| | | | Invention |
| TC-33 | 54Ω/□ | nearly 4 nm | Present |
| | | | Invention |
| TC-34 | 54Ω/□ | nearly 6 nm | Present |
| | | | Invention |

As it clearly seen in the results of Table 3, average surface resistance value (SR(a)) of Transparent Electrode TC-31 is superior to Transparent Electrode TC-30. This may be assumed to be due to the following reasons. By application of a calendering finish after formation of the above Ag nanowires layer, the Ag nanowires are brought into closer contact with each other to enhance electrical conductivity among their Ag nanowires, and at the same time, electrical conductivity between layer B and the Ag nanowires is also enhanced. Further, surface smoothness (Ra(S)) of each transparent electrode in Table 3 depends on the surface roughness of the mold-releasing support employed in preparation of each transparent electrode. Namely, based on the manufacturing method of the transparent electrode of the present invention, it is possible to arbitrarily control the surface roughness of the transparent electrode according to the present invention.

Specifically, by applying the transparent electrode of the present invention to optoelectronic devices such as organic luminescent devices resulting in a short distance between the electrodes, it is possible to minimize short-circuiting of counter electrodes, and the concentration of electric fields due to the highly smoothened surface of the transparent electrode. Further, it is possible to realize uniform intensity of in-plane luminescence of organic luminescent devices. High transparency, high electrical conductivity, and excellent uniformity of surface resistance are widely applicable to electric current driving type optoelectronic devices.

Further, by employing a transparent resin film as a transparent electrode support, the resulting support may preferably applied to optoelectronic devices which require a decrease in weight and an increase in flexibility. Still further, since the transparent electrode of the present invention and the manufacturing method of the transparent electrode of the present invention require no vacuum film formation, whereby they excel in manufacturing cost reduction and enhance environmental friendliness.

### Example 4

### (Preparation of Transparent Electrode TC-40)

According to manufacturing method (4) described above, a transparent elect rode was prepared.

Layer A was formed by applying a dispersion, which was prepared by uniformly dispersing the above Ag nanowire dispersion onto the mold-releasing surface of a mold-releasing support, treated with corona discharge, followed by drying. The added amount of the Ag nanowire dispersion was regulated to attain a coated weight of the Ag nanowires of 0.3 g/m². Subsequently, a solution incorporating UV curable resins and solvents was applied onto a polyethylene terephthalate (PET) support at a total light transmittance of 90%, treated with corona discharge, followed by drying, whereby a binder layer was formed. Thereafter, layer A formed on the above mold-releasing support was brought into pressure contact with the resulting binder layer. While maintaining the above state, the binder layer was cured via exposure to UV radiation. Thereafter, by peeling the mold-releasing support, a conductive layer was formed in which the layer A was fixed in the surface portion of the binder layer on the transparent support. Further, layer B was laminated onto the above conductive layer in such a manner that a solution incorporating PEDOT/PSS and DMSO was uniformly applied onto the above conductive layer to attain a dried layer thickness of 150 nm, followed by drying, whereby Transparent Electrode TC-40 of the present invention was prepared.

Total light transmittance T, average surface resistance value SR(a), standard variation SR(σ), and smoothness Ra(B) of layer B surface, where layer B was brought into contract with layer A, were determined via the same method as used in Example 1. As a result, it was confirmed that Transparent Electrode TC-40 of the present invention, prepared via manufacturing method (4) of the present invention, exhibited identical performance and characteristics of Transparent Electrode TC-10 of the present invention prepared via manufacturing method (3), described in Example 1.

What is claimed is:

1. A method for preparing a transparent electrode, comprising the steps in the sequence set forth:
forming a conductive layer B comprising a conductive polymer on a mold-releasing surface of a mold-releasing support;
laminating a conductive layer A comprising a conductive fiber on the conductive layer B to form a laminated composition; and
transferring the laminated composition of the conductive layer B and the conductive layer A onto the transparent support,
wherein the conductive fiber in the conductive layer A is made of a Ag nanowire; and
a first surface of the conductive layer b contacting with the conductive layer A has a smoothness Ra(B):
Ra(B)≦30 nm.

2. The method for preparation of a transparent electrode of claim 1,
wherein a second surface of the conductive layer B located farther than the first surface of the conductive layer B from the transparent support has a smoothness Ra(S):
Ra(S)≦5 nm.

3. The method for preparation of a transparent electrode of claim 1,
wherein the conductive polymer in the conductive layer B is selected from the group consisting of polypyrrole, polyaniline, polythiophene, polythienylene vinylene, polyazulene, polyisothianaphthene, polycarbazole, polyacetylene, polyphenylene, polyphenylene vinylene, polyacene, polyphenyl acetylene, and polynaphthalene.

4. The method for preparation of a transparent electrode of claim 3,
wherein the conducive polymer in the conductive layer B is selected from the group consisting of polyaniline, polypyrrole and polythiophene.

5. The method for preparation of a transparent electrode of claim 4,
wherein the conductive polymer in the conductive layer B is PEDOT (3,4-ethylenedioxythiophen) doped with PSS (polystyrene sulfone).
